(19) United States
(12) Patent Application Publication
(10) Pub. No.: US 2009/0186732 A1
(43) Pub. Date: Jul. 23, 2009

(54) SILENT CHAIN

(75) Inventors: Takashi Tohara, Osaka (JP); Toyonaga Saito, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., Osaka (JP)

(21) Appl. No.: 12/335,836

(22) Filed: Dec. 16, 2008

(30) Foreign Application Priority Data
Jan. 23, 2008 (JP) 2008-012597

(51) Int. Cl. F16G 13/04

(52) U.S. Cl. 474/213

(57) ABSTRACT

In a silent chain having guide rows composed of guide plates, and inner guide row plates, the guide row plates being connected, by connecting pins, in alternating, interleaved relationship with plates of non-guide rows, the diameters of the pin holes in the plates of each non-guide row vary with increasing distance from the guide plates. Optionally the diameters of the inner plates in the guide rows can also vary with increasing distance from the guide plates.

### CROSS-REFERENCE TO RELATED APPLICATION

This application claims priority on the basis of Japanese patent application 2008-012597, filed Jan. 23, 2008. The disclosure of Japanese application 2008-012597 is hereby incorporated by reference.

### FIELD OF THE INVENTION

This invention relates to a silent chain having improvements by which the forces that act on the link plates as a result of tension applied to the chain are more uniformly distributed.

### BACKGROUND OF THE INVENTION

A typical silent chain comprising rows of plates, defined as guide rows and non-guide rows respectively. Each guide row is composed of a pair of opposed guide plates and a plurality of inner guide row plates disposed between the guide plates. Each of the inner guide row plates has a pair of pin holes. Each non-guide row is composed of a plurality of non-guide row plates, and each of the non-guide row plates also has a pair of pin holes. The number of non-guide row plates in each non-guide row exceeds, by one, the number of inner guide row plates in each guide row. The guide rows and non-guide rows are arranged alternately along the length of the chain, and the plates of the each non-guide row are interleaved with the plates of two adjacent guide rows and extend between the guide plates of the adjacent guide rows. Connecting pins, which are fixed to the guide plates, extend through pin holes in the interleaved inner guide row plates and non-guide row plates in order to connect the guide rows and the non-guide rows in articulating relationship.

As shown in FIGS. 11 and 12, the conventional silent chain 500 has a guide row 520 composed of a pair of guide plates 521 and 522, a plurality of inner guide row plates 526, 527, 528 and 529 arranged between the guide plates 521 and 522, and a non-guide row 530 composed of inner link plates 531, 532, 533, 534 and 535, the number of which exceeds by one the number of inner link plates in the guide row 520. The plates of the non-guide row are interleaved with the plates of the guide row. Pins 511 and 512 are securely fitted into pairs of front and rear pin holes 551, 552, 561 and 562 of the respective guide plates 521 and 522, and extend loosely through holes in the link plates 526, 527, 528, 529, 531, 532, 533, 534 and 535 so that the guide rink row 520 and the non-guide row 530 are connected but articulable.

The pitch P of the connecting pins 511 and 512 is the same as that of the pin holes of the inner guide row plates 526, 527, 528 and 529. Equal annular clearances C exist between outer circumferential surfaces of the pins 511 and 512 and the inner circumferential surfaces of pin holes 551, etc., of the respective inner link plates 526, 527, 528 and 529.

When a tensile force acts on the silent chain 500, deflection occurs in the pins 511 and 512. As the deflections of the pins 511 and 512 increase, the pins come into abutting contact with the inner circumferential surfaces of the pin holes of the inner link plates 527 and 528, which are farthest from the outer link plates.

The tensile load becomes concentrated in the guide plates 521 and 522 and in the inner guide row plates 527 and 528. On the other hand, in the non-guide link row 530, tensile forces are concentrated in the outermost link plates 531 and 535 as a result of deflections of the pins 511 and 512, as explained in U.S. Pat. No. 5,989,141.

However, in the conventional silent chain, wear, elongation and rupture are liable to occur in the link plates in which the load is concentrated. To increase the plate strength, countermeasures such as increasing the plate thickness can be adopted. However, in the case of a chain used in the valve timing system of an engine, for example, where compactness and lightness in weight are important, increasing plate thickness has not been a satisfactory solution.

Accordingly, an object of the invention is to solve the above-described problems and to provide a silent chain, which is light in weight, compact, and torque resistant, and in which tensile force is more uniformly distributed despite deflection of the connecting pins, so that wear, elongation and the likelihood of rupture, are reduced.

### SUMMARY OF THE INVENTION

The silent chain according to the invention comprising rows of plates, defined as guide rows and non-guide rows respectively. Each guide row is composed of a pair of opposed guide plates and a plurality of inner guide row plates disposed between the guide plates. Each of the inner guide row plates has a pair of pin holes. Each non-guide row is composed of a plurality of non-guide row plates, and each of the non-guide row plates also has a pair of pin holes. The number of non-guide row plates in each non-guide row exceeds, by one, the number of inner guide row plates in each guide row. The guide rows and non-guide rows are arranged alternately along the length of the chain, and the plates of the each non-guide row are interleaved with the plates of two adjacent guide rows and extend between the guide plates of the adjacent guide rows. Connecting pins extend through pin holes in the interleaved inner guide row plates and non-guide row plates in order to connect the guide rows and the non-guide rows in articulating relationship. The chain is characterized by the fact that the diameters of the pin holes in the plates of each non-guide row vary with increasing distance from the guide plates.

When a tensile force is exerted on the silent chain, causing its pins to be flexed, the tensile force is substantially uniformly transmitted to the link plates of the non-guide link row. Therefore, concentration of load on specific link plates is avoided. Wear, chain elongation, and likelihood of rupture are reduced. Moreover, these effects can be achieve in a chain that is both light in weight and compact, and that exhibits high torque resistance.

In an alternative embodiment, the diameters of the pin holes in the plates of each guide row can also vary with increasing distance from the guide plates. Therefore concentration of load on specific inner link plates of the guide rows is avoided, and wear, chain elongation, and likelihood of rupture are further reduced.

### BRIEF DESCRIPTION OF THE DRAWINGS

FIG. 1 is a side elevational view of a part of a silent chain according to the invention;

FIG. 2 is a plan view of a portion of the chain;

FIG. 3 is a side elevational view of a guide plate of the chain;

FIG. 4 is a cross-sectional view of a first embodiment of a silent chain according to the invention;

FIG. 5 is an elevational view of a toothed link plate in a guide link row of the silent chain of FIG. 4;

FIG. 6 is a set of elevational views of the link plates of a non-guide link row of the chain of FIG. 4;

FIG. 7 is an exaggerated cross-sectional view of the chain of FIG. 4, illustrating the bending of the connecting pins of the chain when the chain is under tension;

FIG. 8 is a cross-sectional view of a second embodiment of a silent chain according to the invention;

FIG. 9 is a set of elevational views of the link plates of a guide link row of the chain of FIG. 8

FIG. 10 is a cross-sectional view of the chain of FIG. 8, illustrating the bending of the connecting pins of the chain when the chain is under tension;

FIG. 11 is a cross-sectional view of a conventional silent chain; and

FIG. 12 is a cross-sectional view illustrating the bending of the connecting pins of the conventional chain when the chain is under tension.

### DETAILED DESCRIPTION OF THE PREFERRED EMBODIMENTS

In the chain according to the invention, the diameters of the pin holes of the non-guide row plates, and, optionally, the diameters of the pin holes of the inner guide row plates, vary according to the distance from the guide plates of the chain. Varying the diameters of the pin holes tends to equalize the forces applied to the link plates when the connecting pins are deflected as a result of tension applied to the chain.

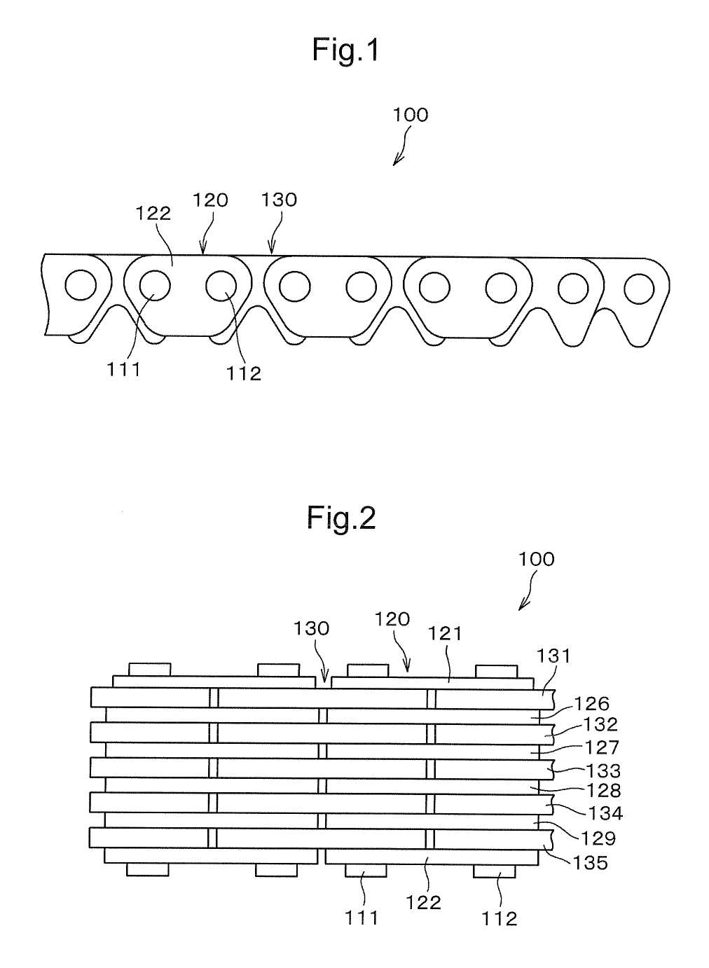

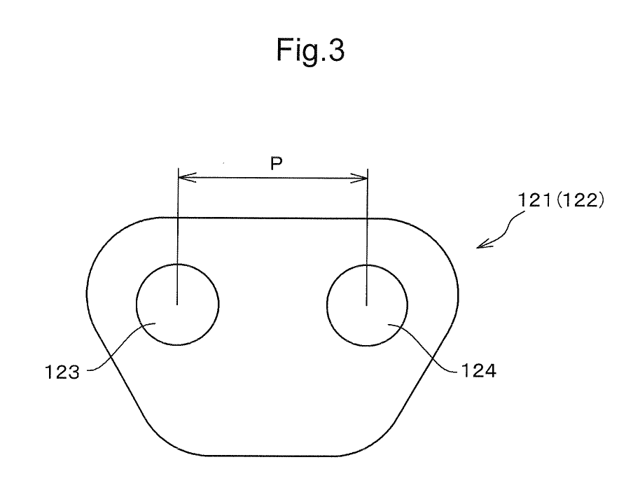

As shown in FIGS. 1 to 3, in a silent chain 100, a guide link row 120 is composed of a pair of guide plates 121 and 122 and a plurality of toothed inner link plates 126, 127, 128 and 129, arranged between the guide plates 121 and 122. A non-guide link row 130 is composed of toothed link plates 131, 132, 133, 134 and 135, the number of which exceeds, by one, the number of inner link plates 126, 127, 128 and 129 of the guide link row 120. The guide rows and non-guide rows are arranged alternately along the length of the chain, and the plates of the non-guide rows are interleaved with the plates of the guide rows.

Connecting pins 111 and 112 are respectively inserted into and fixed to, front and rear pin holes of the guide plates 121 and 122. Each pin extends through pin holes of the link plates 126, 127, 128, 129, 131, 132, 133, 134 and 135, connecting the interleaved rows of plates together while allowing articulation of the chain.

The diameters of pin holes 123 and 124 in the respective guide plate 121 and 122 are smaller than the diameters of pins 111 and 112. The pins 111 and 112 are press-fit into the guide plates 121 and 122. Further, the diameters of the pin holes of the inner link plates of the guide rows 120 and the diameters of the pin holes of the link plates of the non-guide link rows 130 are larger than the diameters of pins 111 and 112 so that toothed link plates can rotate relative to the connecting pins.

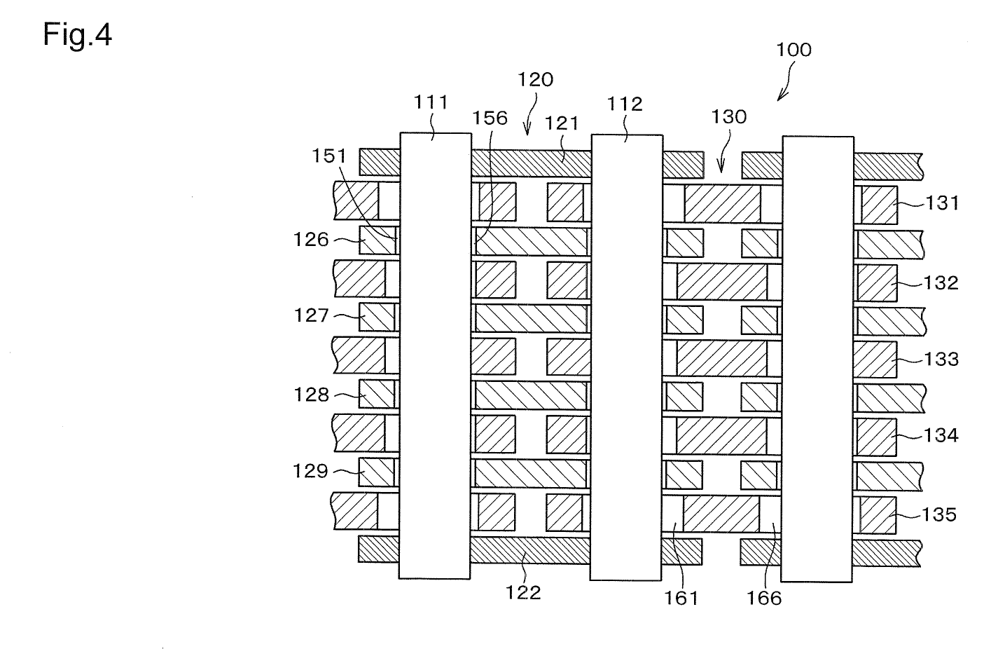

As shown in FIG. 4, the diameters of the pin holes of the inner link plates 126, 127, 128 and 129 of the guide row 120 are uniform, whereas the diameters of the pin holes of the link plates 131, 132, 133, 134 and 135 of the non-guide link row 130 vary in accordance with the distance of link plates 131, 132, 133, 134 and 135 from the respective guide plates 121 and 122.

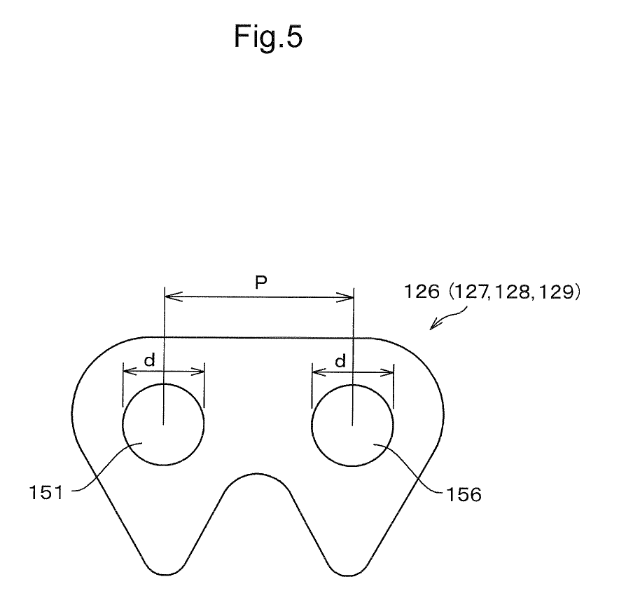

The inner link plates 126, 127, 128 and 129 of the guide link row 120 are all the same size, and, as shown in FIG. 5, the diameters d of the holes 151 and 156 are the same for of each of plates 126, 127, 128 and 129, and slightly larger than the diameters of the connecting pins 111 and 112, as shown in FIG. 4.

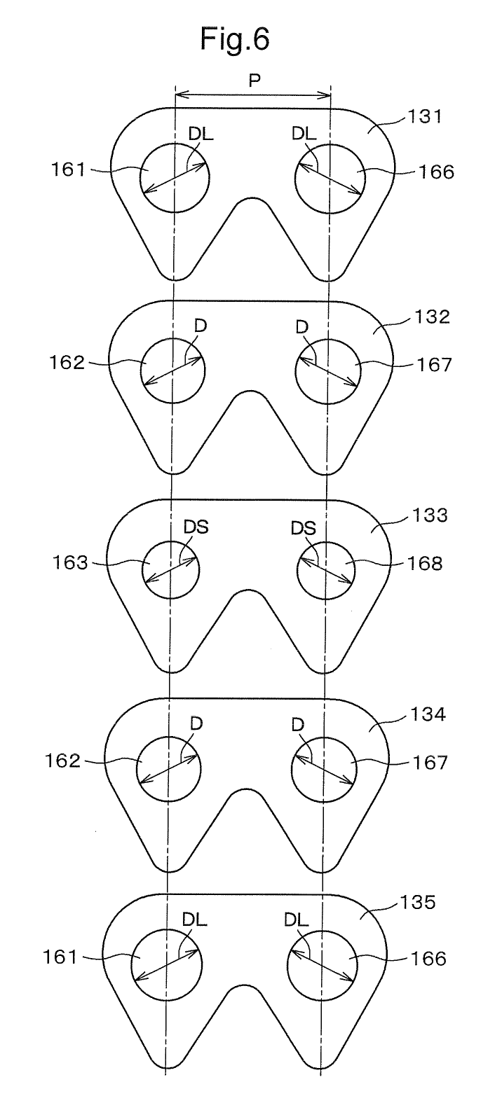

As shown in FIG. 6, in the link plates 131, 132, 133, 134 and 135 of the non-guide link row 130, the diameter DL of the pin holes 161 and 166 of link plates 131 and 135, which are the closest to the guide plates 121 and 122, is larger than the standard diameter D of the pin holes in a conventional link plate. On the other hand, the diameter DS of the pin holes 163 and 168 of the innermost link plate 133, which is farthest from the guide plates 121 and 122, is smaller than the standard diameter D. Thus, although the pin holes of all the plates of the non-guide rows have the same pitch P, i.e., the same center-to-center distance, the diameters of the pin holes decrease with increasing distance from the guide plates.

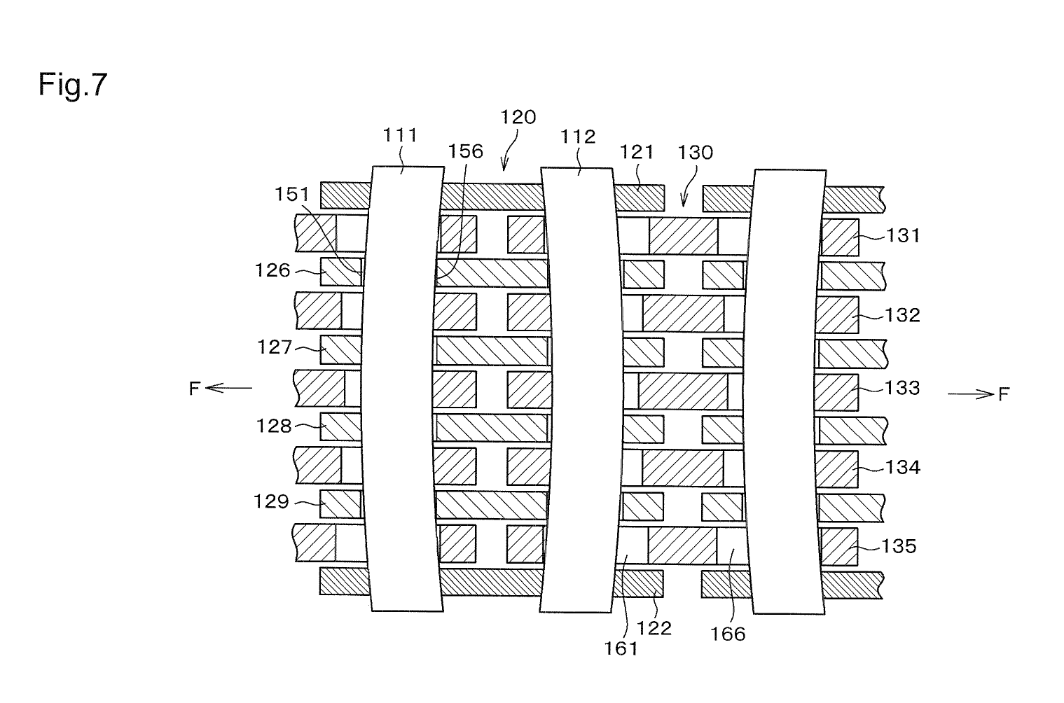

When tensile force is exerted on the silent chain 100, as shown in FIG. 7, the pins 111 and 112 in a guide row 120 flex co that their central portions bulge away from each other. However, since the diameters of the pin holes of the non-guide row link plates decrease with increasing distance from the guide plates, the pin holes of the non-guide row 130 more uniformly contact the pins so that the tensile load is more uniformly shared by the plates of the non-guide row. Concentration of load on specific link plates is avoided, and wear, chain elongation, and likelihood of rupture are reduced. Moreover, the chain can be made light in weight, compact, highly resistant to torque, and stronger without increasing the thicknesses of the plates.

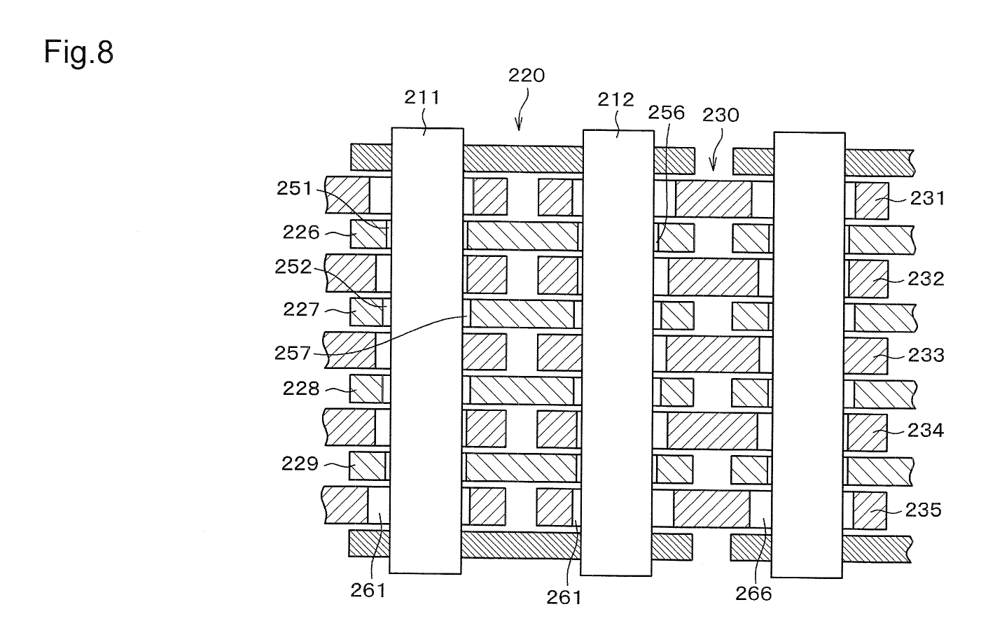

In a second embodiment, shown in FIG. 8, a silent chain 200 comprises non-guide row link plates 231, 232, 233, 234 and 235, the pin holes of which have a diameter variation as in the first embodiment, and guide rows 220, in which the guide row link plates 226, 227, 228 and 229 also have pin holes with diameters that vary in accordance with distance from the guide plates 221 and 222.

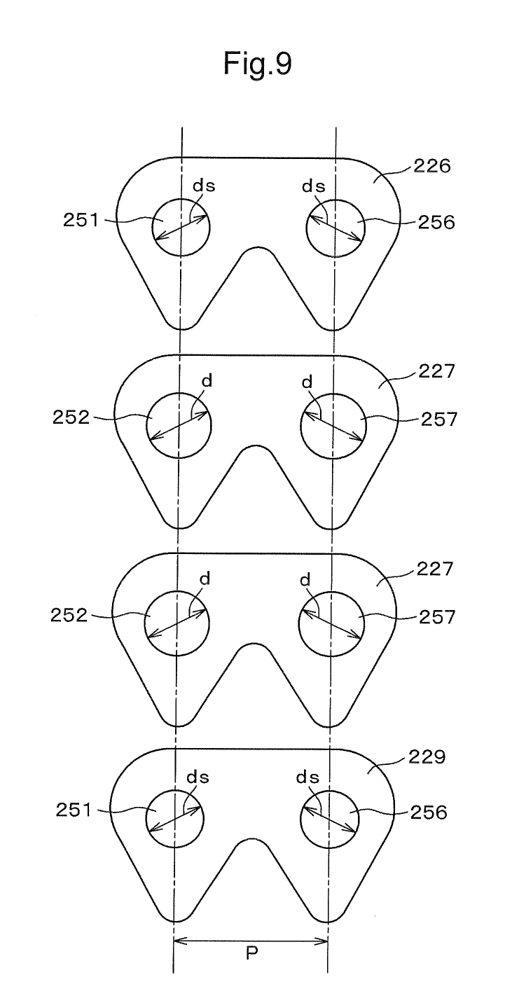

In the inner link plates 226, 227, 228 and 229 of the guide link row 220, as shown in FIG. 9, the diameters ds of the pin holes 251 and 256 of inner link plates 226 and 229, which are the closest to the guide plates 221 and 222 respectively, is less than the standard diameter d of the pin holes of a conventional link plate. The diameter of pin holes 252 and 257 of the inner link plates 227 and 228, which are farther from the guide plates 221 and 222, is the same as the standard diameter d. Thus, in the inner link plates of the guide rows, the pin hole diameter increases with increasing distance from the guide link plates.

The pin holes in the non-guide row link plates 231, 232, 233, 234 and 235 have the same diameter relationship as that of the pin holes of the non-guide row guide plates in the first embodiment, as shown in FIG. 6. That is, the pin hole diameter decreases with increasing distance from the guide plates.

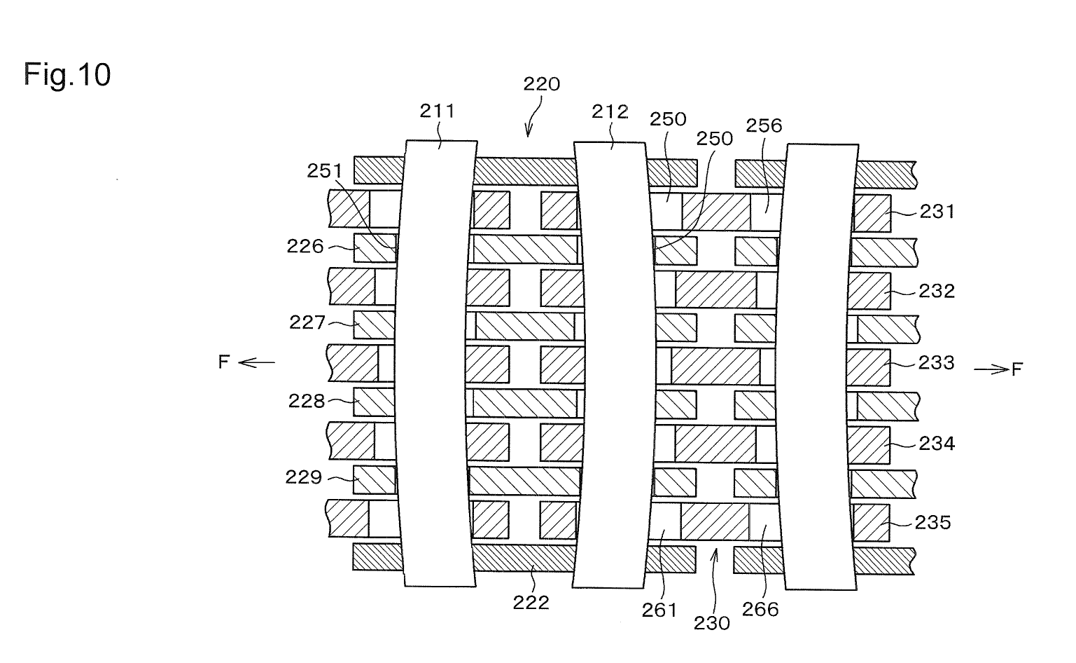

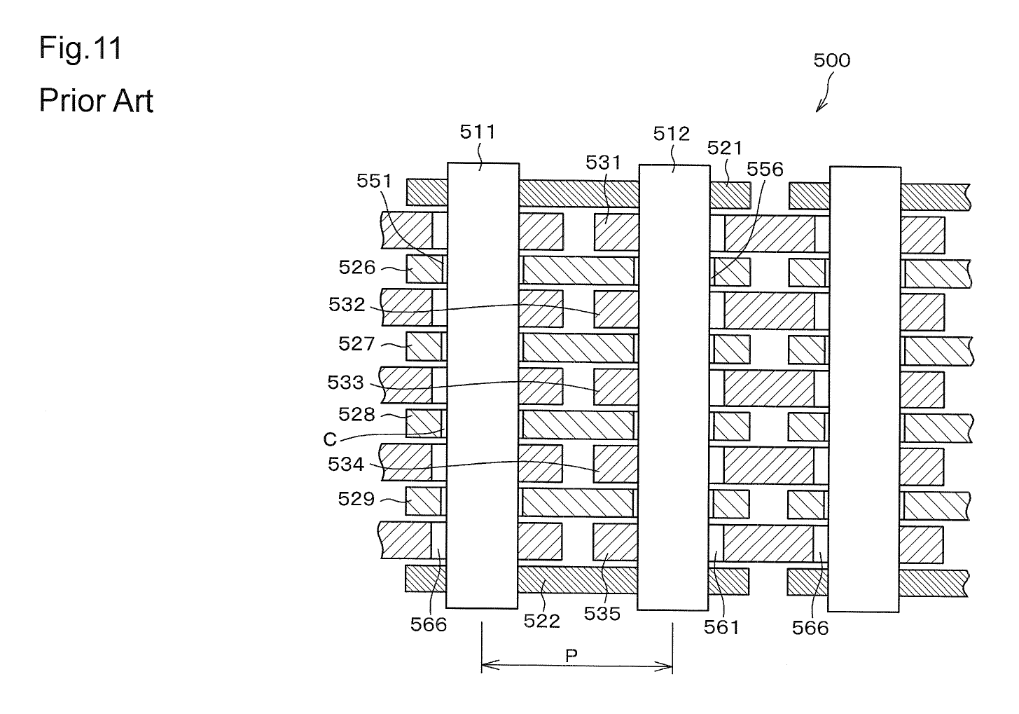

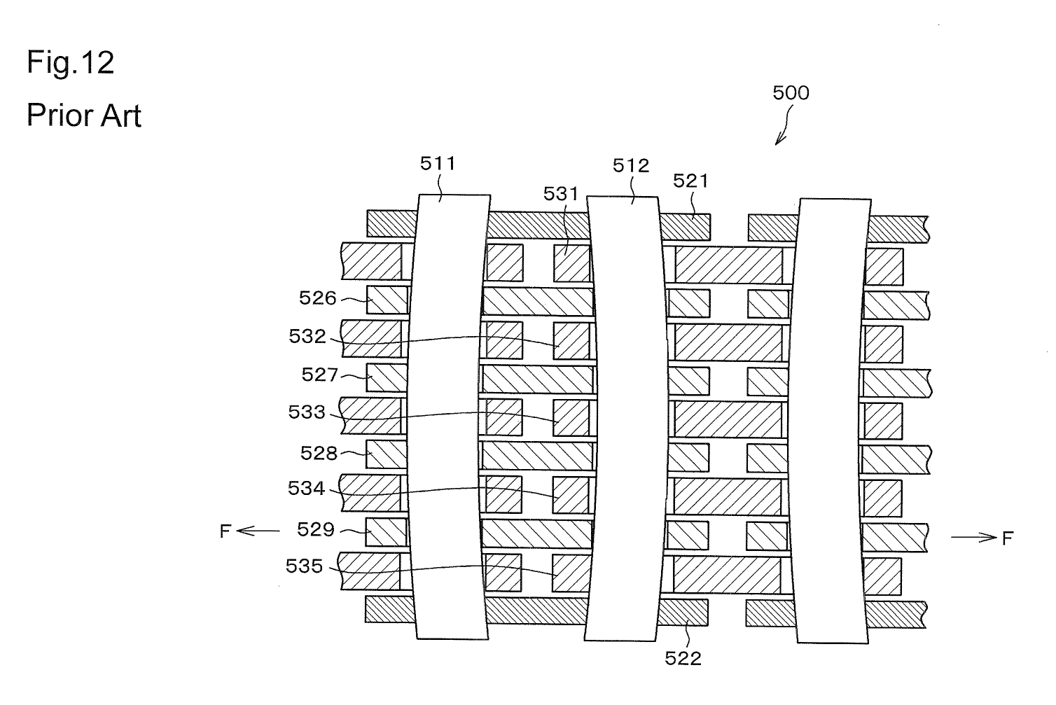

When tensile force is exerted on the silent chain 200, as shown in FIG. 10, the connecting pins 211 and 212 of each guide row 220 are flexed in such a way their central portions bulge away from each other. However, as a result of the above-describe variations in the diameters of the pin holes of the link plates in both the non-guide rows and the guide rows, the tensile load is more uniformly shared among the plates of the guide rows as well as among the plates of the non-guide rows. Thus, still further improvements in resistance to wear, elongation and rupture can be realized. Here again, as in the first embodiment, a chain which is lightweight and compact, and which exhibits high torque resistance, can be obtained without increasing its plate thickness in order to achieve adequate strength.

It should be understood that the diameters of the holes in the link plates can be selected depending on materials, pin size, flexion characteristics of the connecting pins, conditions of use, etc., and that the chains do not necessarily include plates having pin holes diameters of the pin holes of standard diameters.

We claim:

1. A silent chain comprising:
guide rows, each composed of a pair of opposed guide plates and a plurality of inner guide row plates disposed between said pair of guide plates, each of said inner guide row plates having a pair of pin holes;
non-guide rows, each composed of a plurality of non-guide row plates, each of said non-guide row plates also having a pair of pin holes;
the number of non-guide row plates in each non-guide row exceeding by one the number of inner guide row plates in each guide row, the guide rows and non-guide rows being arranged alternately along the length of the chain, and the plates of the each non-guide row being interleaved with the plates of two adjacent guide rows and extending between the guide plates of said adjacent guide rows; and
connecting pins extending through pin holes in the interleaved inner guide row plates and non-guide row plates, said pins connecting the guide rows and the non-guide rows in articulating relationship;
wherein the diameters of the pin holes in the plates of each non-guide row vary with increasing distance from the guide plates.

2. A silent chain according to claim 1, wherein the diameters of the pin holes in the plates of each non-guide row decrease with increasing distance from the guide plates.

3. A silent chain according to claim 1, in which the diameters of the pin holes in the plates of each guide row also vary with increasing distance from the guide plates.

4. A silent chain according to claim 2, in which the diameters of the pin holes in the plates of each guide row increase with increasing distance from the guide plates.
